(19) United States
(12) Patent Application Publication
(10) Pub. No.: US 2025/0328869 A1
(43) Pub. Date: Oct. 23, 2025

(54) ARTIFICIAL INTELLIGENCE AGENT SYSTEM FOR INTERVIEW AND COMPREHENSIVE SKILLS ASSESSMENT OF CANDIDATES

(71) Applicant: Debi Prasad Mishra, Yarrow Point, WA (US)

(72) Inventor: Debi Prasad Mishra, Yarrow Point, WA (US)

(21) Appl. No.: 19/186,083

(22) Filed: Apr. 22, 2025

Related U.S. Application Data
(60) Provisional application No. 63/637,638, filed on Apr. 23, 2024.

(51) Int. Cl. G06Q 10/1053; G06Q 10/0631

(52) U.S. Cl. CPC G06Q 10/1053; G06Q 10/063112

(57) ABSTRACT

A system and method for generating a human expert-like fully interactive interview via an artificial intelligence agent system is provided. The method may include the steps of: analyzing a job post to extract skill and behavior traits of the job post via a job benchmark analysis module running on a computing platform; analyzing a candidate resume of a candidate to extract skills and work proof via a candidate resume analysis module running on the computing platform; curating a plurality of questions and an interview structure based on data of the candidate resume and the extracted skill and behavior traits of the job post via a question selector and plan generator module running on the computing platform; generating the artificial intelligence agent on a client device via an interactive interview agent module running on the computing platform; and conducting an interview of the candidate via the artificial intelligence agent.

### CROSS-REFERENCE TO RELATED APPLICATIONS

This invention claims priority, under 35 U.S.C. § 120, to the U.S. Provisional Patent Application No. 63/637,638 to Debi Prasad Mishra filed on Apr. 23, 2024, which is incorporated by reference herein in its entirety.

### FIELD OF THE INVENTION

The present invention relates to the field of conducting job interviews and determining whether a candidate has the skills and behavioral traits to meet the requirements of a job.

### BACKGROUND OF THE INVENTION

Automation for accurate and personalized assessments of skills will go a long way towards advancing society by matching human potential to productive work. While there are significant ways technology has been applied to improve the recruiting process, the hardest part has been to replace the human expert who performs the actual interview, assessment and hiring decision. Efforts have been made to apply Large Language Models (LLMs) to help with assessment, but the technical barrier to reach human-like expert to conduct a full interview has not been solved yet.

Therefore, there exists a need for novel systems and method that may be used for conducting job interviews and determining whether a candidate has the skills and behavioral traits to meet the requirements of a job

### BRIEF SUMMARY OF THE INVENTION

An artificial intelligence agent system for interview and comprehensive skills assessment of candidates is provided which has been developed in response to the current of the art, and to address the gaps and needs in art that have not yet been fully solved by currently available automated interviewing systems and methods. Accordingly, the system is configured to provide a fully human-like and automated job interview assessment system and method including a processor over a computerized network.

According to embodiments consistent with the principles of the present invention, a method for generating a human expert-like fully interactive interview via an artificial intelligence agent system is provided. Preferably, the method may include the steps of: analyzing a job post to extract skill and behavior traits of the job post via a job benchmark analysis module running on a computing platform; analyzing a candidate resume of a candidate to extract skills and work proof via a candidate resume analysis module running on the computing platform; curating a plurality of questions and an interview structure based on data of the candidate resume and the extracted skill and behavior traits of the job post via a question selector and plan generator module running on the computing platform; generating the artificial intelligence agent on a client device via an interactive interview agent module running on the computing platform, in which the artificial intelligence agent is displayed on a display screen of the client device, in which a speaker of the client device is operable to output audio data of the artificial intelligence agent, in which a camara of the client device is operable to record video data of the candidate, and in which a microphone of the client device is operable to audio responses of the candidate; and conducting an interview of the candidate via the artificial intelligence agent, in which the artificial intelligence agent interacts with the candidate using a large language model, using the plurality of questions that are output to the candidate via the speaker of the client device, using audio responses from the candidate recorded by the microphone of the client device, and using video data of the candidate recorded by the camera of the client device, and in which the audio responses are processed via the large language model so that the artificial intelligence agent can handle distractions, interruption, and arbitrary questions from the candidate while the artificial intelligence agent records audio responses, via the microphone, from the candidate for each question of the plurality of questions. Preferably, the method may include the step of performing an automated skills assessment for arbitrary skills of the candidate via a transcript analyzer assessment module.

Numerous objects, features and advantages of the present invention will be readily apparent to those of ordinary skill in the art. Some example objects of the present invention are listed below.

One object of the present invention is to provide a system and method to automate high quality, personalized and fine-grain assessment of skills at scale, the invention includes other innovations in the process of delivering this goal. A key innovation of the present invention is the ability of the artificial intelligence agent to conduct an online interview that is very close to a real human interview, with free-form interactions. Another key innovation is the ability of the artificial intelligence agent to assess behavioral traits by asking probing questions about a specific event or situation and then gain insight into the mind of the candidate by analyzing the response patterns. Yet another key innovation is the artificial intelligence agent's ability to prevent plagiarism through detection of it and also via audio/video signatures. The invention scales across languages and is able to conduct interviews in many languages and as needed adapt to the linguistic needs of the candidate. The invention is also job domain agnostic, in the sense that, it can take any job post and work out an interview plan based on it. That is possible as the invention does not depend upon a human curated question bank, rather crafts a question bank dynamically based on the job post. Finally, the invention generates feedback report with granular scores and very detailed explanation of its rationale for the scoring.

This invention goes beyond the state of the art to fully automate the interview process without losing human-like interactivity and expertise. Advances in generative AI has made it possible for us to tackle this problem and solve it at planet scale without any barriers on languages to conduct the interview and without any limitations on kinds of jobs that the invention can interview against.

### BRIEF DESCRIPTION OF THE DRAWINGS

FIG. 1 shows an example of the entity relationship between Job Roles and Job Domains according to various embodiments described herein.

FIG. 2 Shows the structural hierarchy for question bank database—with job domains, skill categories and skill subcategories according to various embodiments described herein.

FIG. 3 shows a block diagram of some software components used by an artificial intelligence agent system for interview and comprehensive skills assessment of candidates according to various embodiments described herein.

FIG. 4 shows a block diagram of some service dependencies of the key software components according to various embodiments described herein.

FIG. 5 shows a block diagram of an example structure of Core Values with multiple behaviors attached to each Core Value according to various embodiments described herein.

FIG. 6 shows a block diagram of a first example method which may be performed by the system for interview and comprehensive skills assessment of candidates according to various embodiments described herein.

FIG. 7 depicts a block diagram of a second example method which may be performed by the system for interview and comprehensive skills assessment of candidates according to various embodiments described herein.

FIG. 8 shows an illustrative example of some of the components and computer implemented methods which may be found in an artificial intelligence agent system for interview and comprehensive skills assessment of candidates according to various embodiments described herein.

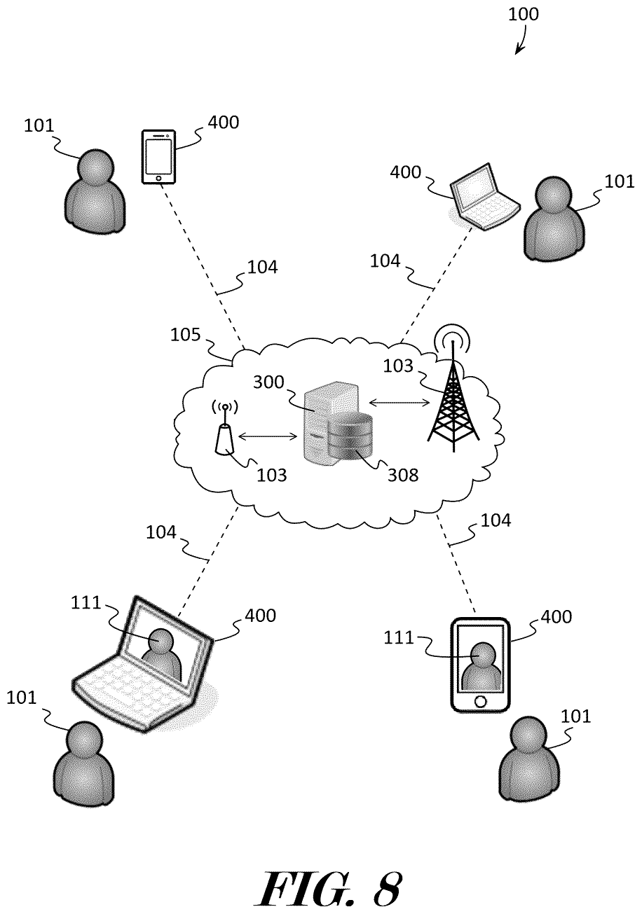

FIG. 9 shows a block diagram showing an example of a server which may be used by the system as described in various embodiments herein.

FIG. 10 depicts a block diagram illustrating an example of a client device which may be used by the system as described in various embodiments herein

### DETAILED DESCRIPTION AND BEST MODE OF IMPLEMENTATION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used in this application, the term “about” or “approximately” refers to a range of values within plus or minus 15% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the terms “computer” and “computing device” refer to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software, with servers and client devices comprising exemplary computing devices.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. N on-limiting examples of client devices include: personal computers (PCs), workstations, servers, laptops, tablet PCs including the iPad, cell phones including iOS phones made by Apple Inc., Android OS phones, Microsoft OS phones, Blackberry phones, Apple iPads, Anoto digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e., a “wireless network”) which may include BLE (Bluetooth), LoRa and LoRaWAN (and other low-power, wide-area (LPWA) networking protocols), Wi-Fi, and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigbee network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e., information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

For the purposes of promoting an understanding of the principles of the invention, reference will now be made to the exemplary embodiments illustrated in the drawings, and specific language will be used to describe the same. It will be understood that no limitation of the scope of the invention is thereby intended. Any alterations and/or further modifications of the inventive features described and illustrated herein, and any additional applications of the principles of the invention as illustrated herein which would occur to one skilled in the relevant art and having possession of this disclosure, are to be considered within the scope of the invention.

Many of the functional units described in this specification have been labeled as modules in a generalized manner to particularly emphasize the implementation independence nature. In one instance a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of programmable or executable code may, for instance, comprise one or more physical or logical blocks of computer instructions which may, for instance, be organized as a module, procedure, or function.

An artificial intelligence agent system (“the system”) 100 is provided which may be used for interview and comprehensive skills assessment of candidates 101. Candidates 101 may include individuals such as job applicants, current employees, and other individuals that desire to have their skills assessment and performance measured. In preferred embodiments, the system 100 primarily pertains to the field of recruiting and specifically to systems and methods for evaluating a candidate's 101 proficiency in a set of skills and evaluating if the candidate 1010 possesses the skills required for a job. In further embodiments, the system 100 may be used in the field of academia for assessing if a student type of candidate 101 has learnt a subject matter and if so, to what level. In further embodiments, the system 100 may be used by corporations for identifying skill gaps for employees (employees being the candidates 101). It should be understood that the system 100 is domain agnostic and may conduct automated assessments of candidates 101 for most domains an application in which an individual is to be evaluated and interviewed for.

In preferred embodiments, the system 100 delivers automation that can conduct human expert-like interview of a candidate 101 for a broad range of skills. The system 100 can conduct human expert-like interview of a candidate 101 at high scale and low cost. In preferred embodiments, the system 100 may be configured to generate and operate an artificial intelligence agent 111 on a client device 400 of a candidate so that the artificial intelligence agent 111 is configured to conduct a human expert-like interview of a candidate 101 for a broad range of skills. In some embodiments, the system 100 uses an online meeting like user interface and maintains a level of human connection and interactivity that makes it feel like a real human expert at the other end.

The system 100 is configured to facilitate the transfer of data and information between one or more access points 103, client devices 400, and servers 300 over a data network 105. Client devices 400 and servers 300 may send data to and receive data from the data network 105 through a network connection 104 with an access point 103. A data store 308 accessible by the server 300 may contain one or more databases. The data may comprise any information input into the system 100 including information on or describing one or more candidates (users) 101 and any other information described below.

In this example, the system 100 comprises at least one client device 400 (but preferably more than two client devices 400) configured to be operated by one or more users 101. Client devices 400 may include mobile devices, such as laptops, tablet computers, personal digital assistants, smart phones, and the like, that are equipped with a wireless network interface capable of sending data to one or more servers 300 with access to one or more data stores 308 over a network 105, such as a wireless local area network (WLAN). Additionally, client devices 400 may include fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one computing device, such as a client device 400 and/or server 300, programmed to perform one or more of the steps described herein. In some embodiments, more than one client device 400 and/or server 300 may be used, with each being programmed to carry out one or more steps of a method or process described herein.

In some embodiments, the system 100 may comprise an assessment system configured to automatically assess an individual (candidate 101) and an associated job using a computing platform. The system 100 may include a job benchmark analysis module 131 (also “job post analyzer module”) that extracts skills, traits and other benchmarks associated with a job using the text data and other data of a job posting or job description. This also includes generating minimum threshold scores required for skills associated with the job of the job posting or job description. The system 100 also includes a question selector plan generator module 133 (also “questions generator module”) that dynamically generates questions associated with skills listed in the job posting. These may be created on demand when a job is posted and has associated skills and in which the system 100 has not yet created questions for the skills.

The system 100 may include a candidate resume analysis module 132 (also “resume analyzer module”) that extracts work history and other experiences of a candidate, via text data of their resume, and crafts questions to ask the candidate 101 based on that extracted data. The system 100 may include an interactive interview agent module 134 (“interactive interview module”) that may be functionally coupled to the curated question library of the system database 120, the job benchmark analysis module 131 and the candidate resume analysis module 132. Using these and data generated by these modules, the interactive interview agent module 134 conducts a live interview with the candidate 101 using a smart phone app or portal-based user interface module running on a client device 400. This interactive interview agent module 134 may adjust the sequencing of the questions or modify the list of questions dynamically based on answers provided by the candidate 101 to earlier questions and based on the skill levels required for the job. The interactive interview agent module 134 also stores the audio and video transcripts of the interview.

The system 100 may include a transcript analyzer assessment module 135 (also “transcript analyzer module”) that may be functionally coupled to the interactive interview agent module 134 and the transcript audio and video files created by it. Using Large Language Models (LLMs), the transcript analyzer assessment module 135 reviews the contents of the transcript audio and video files (transcripts) for both the verbatim responses as well as the tone of the candidate 101. It scores the candidate 101 against each of the required skills.

The system 100 may include a signature plagiarism module 136 (also “signature analyzer module”) that may be functionally coupled to the interactive interview agent module 134 and the transcript audio video files created by the interactive interview agent module 134. This module preferably checks the audio and video signatures extracted from the transcripts against the prior stored signatures for the candidate 101 to ensure that the right candidate 101 took the interview. It also analyzes the eye tracking of the candidate 101 and background noise to check for other signs of plagiarism.

The system 100 may include a traits analyzer assessment module 137 (also “traits analyzer module”) that can detect behaviors demonstrated by the candidate 101 in different situations. Finally, the system 100 may have a feedback report module 138 that creates a digital document with detail scores and skill gaps of the candidate 101.

The system 100 is able to fully replace a human expert in performing the task of interviewing a candidate 101 against a job post or other position that the candidate 101 desires to fill and create detailed feedback and scoring like human experts can. Using automation and advanced large language models (LLM s), the system 100 creates an artificial intelligence agent 111 which functions as an automated agent that combines a set of powerful capabilities. Generally, an artificial intelligence agent 111 may comprise a digitally generated visual representation of a user or character that may be displayed to a candidate on a display screen 404A of a client device 400. The said artificial intelligence agent 111 may speak to the candidate 101 (e.g., output voice data) using the speakers 404B of a client device 400. The artificial intelligence agent 111 may, for the whole or part, of the interview output or display a static picture or a moving rendering of itself speaking to the candidate 101 using the display screen 404A of a client device 400. First, the artificial intelligence agent 111 is fully bidirectionally interactive and can conduct a complete conversation with the candidate 101 for the interview process. Second, the artificial intelligence agent 111 can analyze the job post and comprehend all the skills and behavioral traits required for the job and then use that to dynamically curate an interview plan with a set of specific domains as well as behavioral questions to ask the candidate 101. Third, the artificial intelligence agent 111 can dynamically probe as needed and adjust the questions to ask based on answers to prior questions. Fourth, the artificial intelligence agent 111 can analyze all the responses—verbatim, tone, gestures and other visual signals—and do an overall assessment of competency of the candidate 101 for each of the skills required for the job. Fifth, the artificial intelligence agent 111 can handle questions and interruptions as well as special requests from the candidate with appropriateness, such as to deny a request or, when appropriate, provide an answer. Sixth, the artificial intelligence agent 111 can conduct interviews in a majority of languages and also can switch between languages as is necessary, while keeping in mind the requirements of language competency as set forth in the job post. Seventh, the artificial intelligence agent 111 can do full behavioral analytics to assess the values and behaviors the candidate 101 would demonstrate in specific situations. Eighth, the artificial intelligence agent 111 is domain agnostic and can conduct interviews for any job or position domain. Ninth, the artificial intelligence agent 111 analyzes continuous video and audio stream data of the candidate 101 being interviewed to check it against the candidates' 101 audio/video signature captured before the interview, as well as monitors against background noise and eye movement of the candidate 101 and combines these to detect plagiarism, which is currently a huge problem with online interviews.

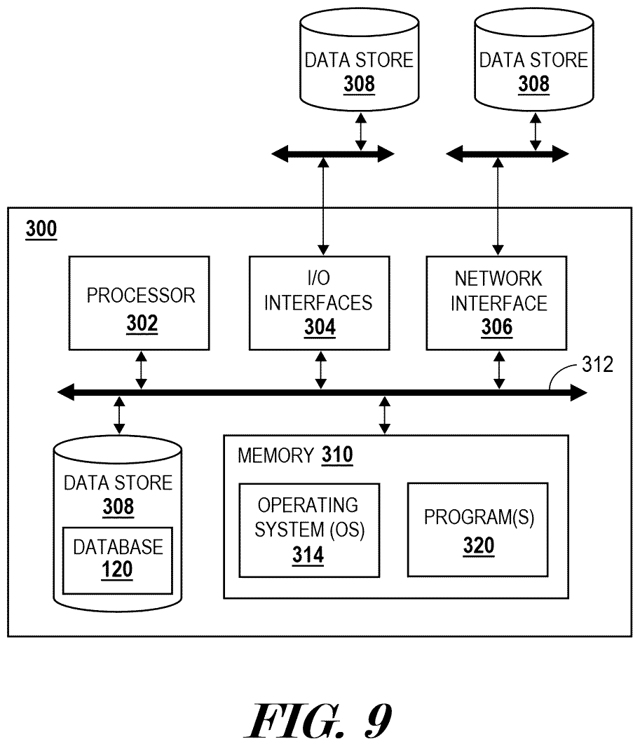

Referring now to FIG. 9, in an exemplary embodiment, a block diagram illustrates a server 300 of which one or more may be used in the system 100 or standalone and which may be a type of computing platform. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 9 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10GbE) or a wireless local area network (WLAN) card or adapter (e.g., 802.11a/b/g/n). The network interface 306 may include address, control, and/or data connections to enable appropriate communications on the network. A data store 308 may be used to store data.

The data store 308 is a type of memory and may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally, in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320, preferably including modules 131-138.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Microsoft Windows 11, Windows Server 2003/2008/2012/2016 (all available from Microsoft, Corp. of Redmond, WA), Solaris (available from Sun Microsystems, Inc. of Palo Alto, CA), LINUX (or another UNIX variant) (available from Red H at of Raleigh, NC and various other vendors), Android and variants thereof (available from Google, Inc. of Mountain View, CA), Apple OS X and variants thereof (available from Apple, Inc. of Cupertino, CA), or the like.

The one or more programs 320 may be configured to implement the various processes, algorithms, methods, techniques, etc. described herein.

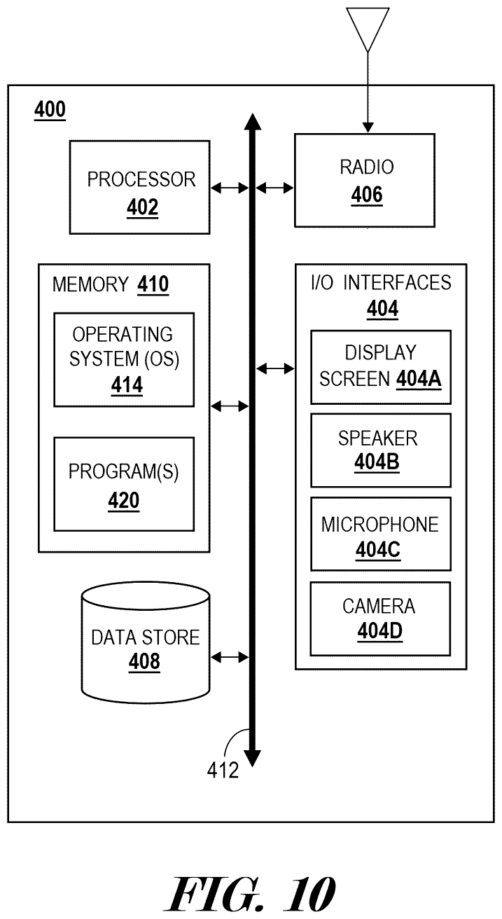

Referring to FIG. 10, in an exemplary embodiment, a block diagram illustrates a client device 400 of which one or more may be used in the system 100 or the like and which may be a type of computing platform. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 10 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display screen 404A, such as a liquid crystal display (LCD), light emitting diode (LED) display, touch screen display, and the like. The I/O interfaces 404 can also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G/5G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 408 may be used to store data and is therefore a type of memory. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs 420, each of which includes an ordered listing of executable instructions for implementing logical functions. In the example of FIG. 10, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, Microsoft Windows 10, Microsoft Windows 11, iOS (available from Apple, Inc.), webOS (available from Hewlett Packard), Blackberry OS (Available from Research in Motion), and the like.

The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network 105 to manipulate information of the system 100.

The system 100 has applicability in many real-world use cases and scenarios, such as for: job interview for hiring; selecting an applicant for a PhD program; assessing if a student meets the passing requirements; and identifying skill and concept gaps that can decide appropriate additional training. There are many dimensions to the innovations provided by the system 100. One dimension is that the system 100 is domain agnostic—in that it can conduct the assessment for most skills and use multiple languages for the interaction as needed. Another dimension is that the assessment is very personalized and customized to the candidate and the job post. The system 100 understands the candidate 101 and their past experiences and accomplishments and thereby can craft an assessment plan that is hard to match for a human assessor without unreasonable resource investment. The system 100 ensures the fidelity of the assessment using audio and video signatures (e.g., recorded audio data and video data) of the candidate 101 to ensure the real person is being assessed. It also preferably uses video surveillance during the interview to ensure there was not much room for plagiarism. The system 100 uses experts in the loop to ensure there is independent audit of the accuracy and to provide guard rails. In preferred embodiments, the system 100 may be delivered as a cloud service via a client device 400 with smart phone apps and web portals as user interfaces, it can support very high scale, and it is able to deliver personalized arbitrary assessments at a very low cost.

In preferred embodiments, the system 100 analyzes a candidate's 101 application (resume, CV, etc.) data alongside the job description to create a customized interview questionnaire. This questionnaire is tailored to the candidate's skills and experience as they relate to the job requirements.

In preferred embodiments, the system 100 may be configured to: analyze documents associated with a candidate 101, such as a candidate's job application and the job description; establish relationships between candidate and job-related competencies which are used to establish the structure of the interview; questions for the interview are selected or generated based on these relationships, focusing on relevant topics; conducting an interactive interview using appropriate user interfaces of a client device 400 operated by the candidate 101 and using an artificial intelligence agent (AI agent) 111; and scoring of the candidate 101 competencies based on analysis of the transcripts of the interview.

Dynamic capabilities of the system 100 may include: generating questionnaires beforehand or adapt dynamically during the interview based on candidate 101 responses; and generating interview structures include branching logic, allowing the flow of questions to adjust in real-time.

As to the cost benefits of the system 100, the system 100 provides an efficient, adaptable, and cost-effective solution for creating high-quality interviews tailored to each candidate 101. The system 100 reduces the need for human experts by using fully interactive AI agents that mirror human-like expertise. The system 100 does not have dependency on human curation of question bank as it generates questions automatically, lowering costs. The system 100 automates the scoring and decision making thus not requiring human resources/time. With the use of natural language processing and intelligent data analysis, the system 100 continuously improves its ability to generate effective interview questions.

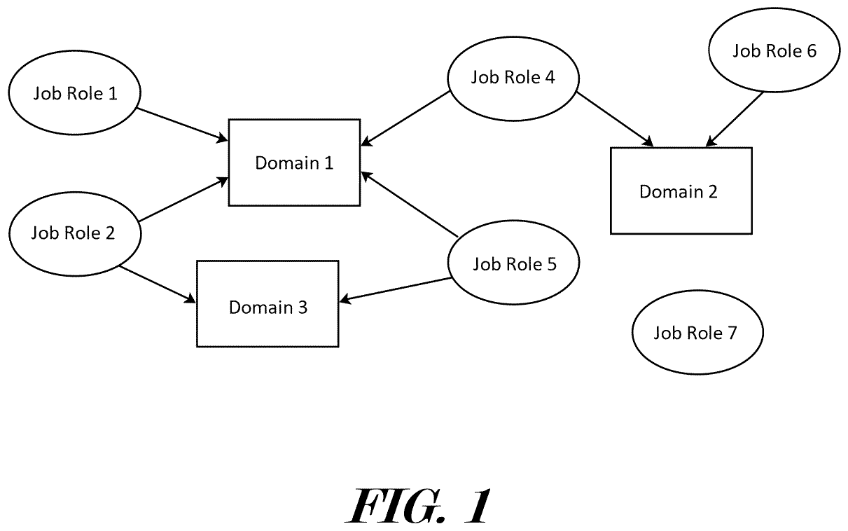

FIG. 1 shows an example of the entity relationship between Job Roles 141 and Job Domains 142 according to various embodiments described herein. A job may be related to many domains—for example, such as a UX engineer needs to know JavaScript as well as Service Ops.

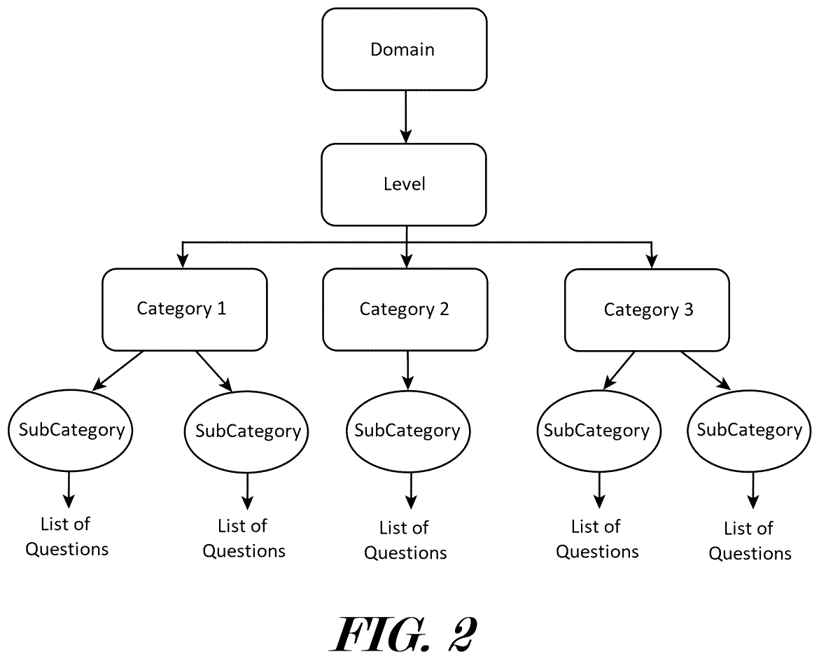

FIG. 2 shows an example of a structural hierarchy for question bank database that may be stored in the system database 120—with job domains 142, levels 143 (e.g., entry level, senior level, expert level, etc.), skill categories (also “categories”) 144, skill subcategories 145, and a list or plurality of questions 146 according to various embodiments described herein. The question bank in the system 100 may be automatically generated and triggered based on new skills it encounters as it ingests a new job post. It then creates questions needed to assess that skill as described below.

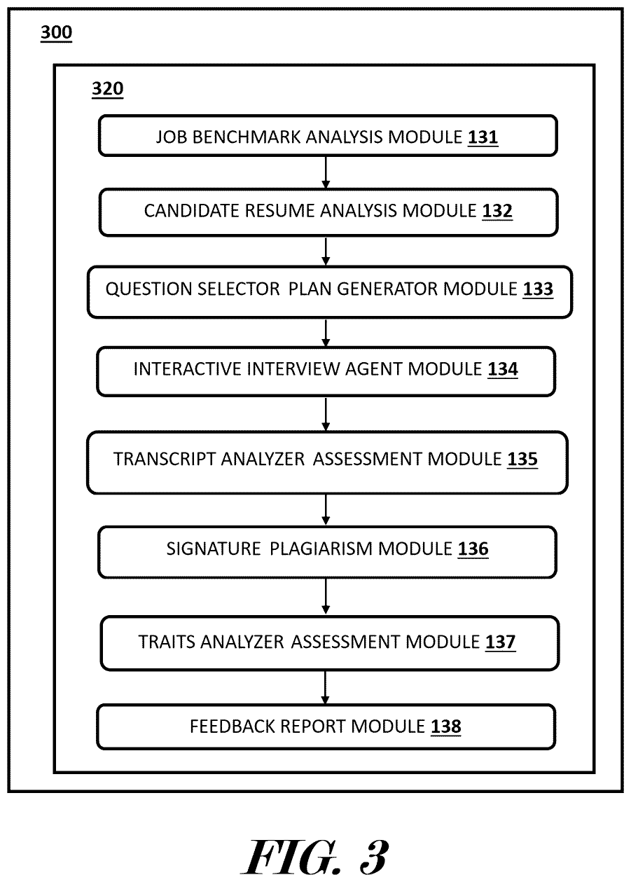

FIG. 3 shows some example software components that may be utilized by the system 100 according to various embodiments described herein. In preferred embodiments, the system 100 may include one or more software modules that may be run on or operated by one or more computing platforms, such as: a job benchmark analysis module 131; a candidate resume analysis module 132; a question selector plan generator module 133; an interactive interview agent module 134; a transcript analyzer assessment module 135; a signature plagiarism module 136; a traits analyzer assessment module 137; and a feedback report module 138.

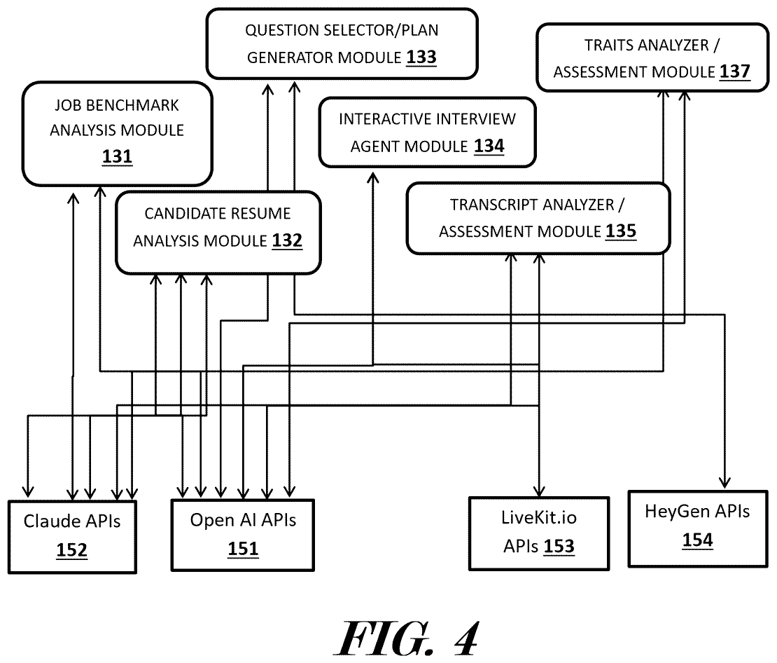

FIG. 4 shows some example service dependencies that may be utilized by the system 100 according to various embodiments described herein. In preferred embodiments, one or more modules 131-138 of the system 100 may be in communication with one or more external cloud services, such as OpenAI APIs 151 by OpenAI, Inc., of San Francisco, California, USA; Claude (language model) APIs 152 developed by developed by Anthropic PBC of San Francisco, California, USA; LiveKit.io Voice AI platform APIs 153 developed by LiveKit Incorporated of San Francisco, California, USA; and HeyGen APIs 154 developed by HeyGen of Los Angeles, California, USA, although the system 100 may utilize other suitable services.

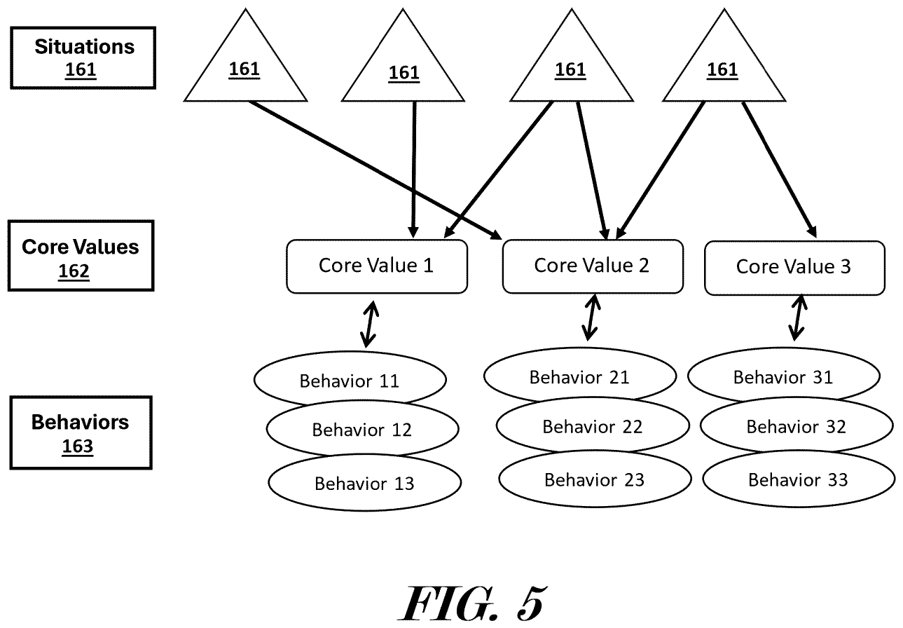

FIG. 5 shows an example structure of core values 162 with multiple behaviors 163 attached to each core value 162. Each core value 162 may be associated with one or more situations 161. In preferred embodiments, there exists a many-many relationships between situations 161 where one exhibits these values 162.

The following sections describe a preferred design and implementation of the key components of the system 100 and are listed below: Core Entities and Relationships; Automated Generation of Skills and Sub Skills; Automated Generation of Question Banks for assessment of specific skills; Automated audio video interaction to evaluate human talent for specific skills; Automated assessment of presence or absence of specific behavioral traits; and Automated hiring decision based on a specific job post.

### Core Entities and Relationships

Job Role and Domains—Job roles may be managed within the video interview job roles collection of the system database 120. Each job role represents a distinct category of job that our invention supports. Job Domains may be created and stored in the video interview domains collection of the system database 120. These are curated in advance, and new domains can be added when the system 100 to support is required to add support for that job domain. Each domain can be associated with one or more job roles. See FIG. 1 for the relationship between entities—Job Roles and Job Domains. For instance, a domain like “M ERN STACK” may be linked to job roles such as “Web Developer” and “Full Stack Developer”. Each domain preferably supports multiple expertise levels to assess the level at which the skill is demonstrated or required.

### Skill Categories and Subcategories

In preferred embodiments, the conceptual knowledge for a job domain may be structured under multiple skill categories and skill subcategories. See FIG. 2. A job domain preferably has one-to-many relationship with skill categories. Each skill in turn can have multiple skill subcategories. For each question the system 100 maintains, preferably in the system database 120, the additional data records of:
Source—Source from where the system obtained this question—eg. LLMs such as OpenAI, Claude, or human curated;
Scale—Weightage of that question (0 to 10);
Good Question Count—as tagged by human Expert reviewers;
Bad Question Count—as tagged by human Expert reviewers; and
Question Video link—such as an AWS s3 bucket link where generated question video with Avatar is stored. The avatar videos are generated in a batch process using Heygen APIs.

### Generating Skill Categories and Subcategories

In preferred embodiments, the system 100 creates this structure using LLMs (such as ChatGPT, OpenAI, and Claude). This process is preferably an offline batch process and is preferably done when a new domain is added to the collection. The system 100 preferably uses multiple prompts to both ChatGPT and Claude to first obtain a list of skill categories and subcategories for that domain and then refines it to weed out corner ones. Experts-in-the-loop individuals also can add/remove the generated skill/subskill structure for a job domain. The output from this process is typically structured in a JSON format. Shown below is an example JSON structure outlining the skill categories and subcategories under the “SEO” domain.

### Sample JSON File for Skill Categories

```
{
  “domain_name”: “SEO”,
  “categories”: [
  {
  “category”: “SEO Fundamentals”,
  “subcategories”: [
    “What is SEO?”,
    “How Search Engines Work”,
    “On-Page vs. Off-Page SEO”,
    “Keyword Research Basics”,
    “SEO Metrics and KPIs”
  ]
  },
  {
  “category”: “Keyword Research”,
  “subcategories”: [
    “Keyword Discovery”,
    “Long-Tail Keywords”
    “Competitive Analysis”,
    “Keyword Tools (e.g., Google Keyword Planner, SEM rush)”,
    “Search Intent”
  ]
  },
  {
  “category”: “On-Page SEO”,
  “subcategories”: [
    “Title Tags and Meta Descriptions”,
    “Header Tags (H1, H2, etc.)”,
    “URL Structure”,
    “Internal Linking”,
    “Image Optimization”,
    “Content Optimization”,
    “Schema Markup”
  ]
  }
  ]
}
```

### Automated Generation of Questions

In preferred embodiments, Questions may be generated using Claude and OpenAI APIs such as:
OpenAI (API: openai.ChatCompletion.create)
Claude (API client: anthropic.Anthropic (messages.create)

To maintain traceability, each question may be associated with its source. FIG. 3 shows the question selector plan generator module 133. Questions may be sourced using the LLMs by querying them using skills and subskills extracted from the job post. By using multiple LLMs, the system 100 obtains a sizable bank of questions for a specific skill/subskill. These questions are further processed to eliminate similar questions. The system 100 preferably has a user interface for subject matter experts to review and remove questions or rate questions with weightage. This is optional as it may further improve the questions but is not required for the system 100 to function.

### Interactive Audio/Video Interview by AI Agent

This section describes the systems and processes of the system 100 used to conduct automated interviews and describes how proficiency in a skill is preferably assessed.

FIG. 3 shows the interactive interview agent module 134. The system 100 delivers or generates an artificial intelligence agent 111 on a client device 400 that may function as an AI Interviewer Agent that can conduct a comprehensive interactive job interview, very much like a human interviewer. The interactive session is preferably created using LiveKit cloud hosting service and preferably uses LiveKit APIs such as:
“create_room”,
“delete_room”,
“transcriptions”, and
“participant_details”.

In preferred embodiments, the system 100 uses OpenAI API openai.realtime.RealtimeModel for the real time interactive dialogue.

In preferred embodiments, first, the interactive interview agent module 134 creates an interview plan with a list of questions for each skill listed in the job post. It narrows this down to make it a manageable set of questions—e.g., around 10-15 questions. It then preferably uses the LiveKit/OpenAI services to start the interactive session with the candidate 101 with audio output via a client device 400 operable by the candidate 101. The interactive interview generated by the interactive interview agent module 134 has a user interface and look and feel of an online audio-video meeting.

The LiveKit/OpenAI session may be initiated with a prompt that is similar to:

```
instructions = (
    “You are going to interview a candidate for the job “f”{job_role}.
You start the interview by introducing yourself as the Interviewer. Greet
the candidate warmly and enthusiastically. Your role is to ask the
interview questions and assess their response. Do not indulge in detailed
explanations. Do not encourage conversations outside the scope of the
questions. Maintain a friendly, professional tone. Control the interview
flow and keep the conversation focused and engaging. If the candidate
seeks additional information about the job role, interview process or has
any concerns please ask them to send an email to “f”{email}” .”
    “Before starting, inform the candidate of the following rule - ensure
your video is enabled throughout the interview and your complete face
stays in the video throughout.”
    “You are asking below questions for this role “f”{job_role}”
    f“{question_list}”
  )
```

The job_role and question_list may be placeholder variables where the dynamically generated questions and job role are provided.

The system 100 can thread multiple LiveKit session back-to-back to conduct various parts of the interview. For example, the general inquiry section may be one session, assessing the candidate's 101 domain knowledge may be another, and there may be a session for assessing behavioral traits.

In preferred embodiments, during each session, the initial short statement will be with a video avatar snippet (such as generated using HeyGen service API calls and stored in system database 120 beforehand). After the initial statement, the rest of a session may be conducted without video avatar of the agent, as this part of the session preferably has dynamic content. During this, part the interactive interview agent module 134 generates the artificial intelligence agent 111 on the client device 400 which communicates using audio data (via speaker 404B) and a static picture, such as of the artificial intelligence agent 111, may be displayed on the display screen 404A of the client device 400. W in some embodiments, while the AI agent 111 is prepped by a selected set of questions, being interactive, it responds to arbitrary interruptions or topics as brought up by the candidate 101. It completes the session preferably after making sure all the questions in question_list were presented to the candidate 101.

### Transcript Analysis and Assessing Skill Proficiency

In some embodiments, after the interview, the AI agent 111 may create a detailed assessment and feedback report with grades for the candidate 101, using recorded audio and video data of the candidate 101 (such as recorded via microphone 404C and camera 404D of client device 400) against all required and optional skills.

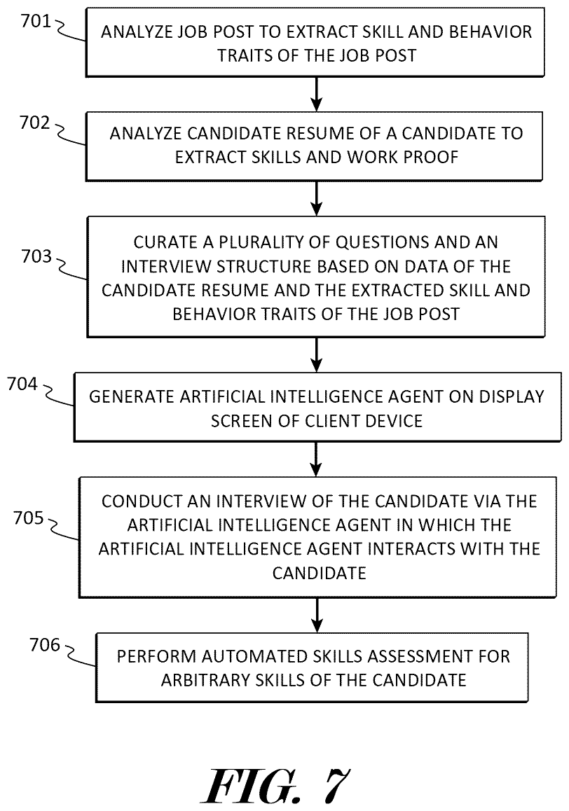

FIG. 3 shows the transcript analyzer assessment module 135. In preferred embodiments, the transcript analyzer assessment module 135 may be configured to perform an automated skills assessment for arbitrary skills of the candidate 101, such as in step 706 of method 700 (FIG. 7), as described below.

In preferred embodiments, the transcript analyzer assessment module 135 uses at least one LLM to score the interview. In some embodiments, the transcript analyzer assessment module 135 may use two LLMs, such as OpenAI and Claude. However, the design of the transcript analyzer assessment module 135 allows additional ones to be plugged in. The purpose of more than one is to make sure the scoring can be triaged across multiple LLMs and detect outliers and remove them.

In preferred embodiments, this process may comprise the following: the transcript analyzer assessment module 135 scores each answer of the candidate 101 to the plurality of questions based on accuracy, relevance and comprehensiveness, and the transcript analyzer assessment module 135 preferably uses the following APIs for obtaining scores.
OpenAI (API: openai.ChatCompletion.create)
Claude (API client: anthropic.Anthropic (messages.create)
   Scores may be normalized in the 0 to 10 range. For each skill listed as required, the transcript analyzer assessment module 135 preferably takes the scores of all questions that are connected to that skill and creates an average using the equation 1:

$$DomainRequiredSkillScore for Skill s = \frac{{\sum }_{Q = q 1}^{qlast} ( Q belongs to Skill s ? StandardizedQuestionSpecificDomaninSkillScore Of Q : 0 )}{{\sum }_{Q = q 1}^{qlast} ( Q belongs to Skill s ? 1 : 0 )}$$

Preferably, the above score computation may be done using two LLMs. With the above, the system 100 will have two sets of all the scores above.

In a similar manner, the transcript analyzer assessment module 135 computes the Expert Scores for each skill using the Expert's question scores.

$$ExpertDomainRequiredSkillScore for Skill s = \frac{{\sum }_{Q = q 1}^{qlast} ( Q belongs to Skill s \&\& Q was scored by the Expert ? EnteredScorebyExpert for the Q : 0 )}{{\sum }_{Q = q 1}^{qlast} ( Q belongs to Skill s \&\& Q was scored by the Expert ? 1 : 0 )}$$

If there are n DomainSkills, the system 100 will end up with
1. n number of DomainSkill scores scores using LLM1: Model1_DomainRequiredSkillScore_k for DomainSkill k (k=1 . . . n)
2. n number of DomainSkill scores using LLM2: Model2_DomainRequiredSkillScore_k for DomainSkill k (k=1 . . . n)
3. n number of DomainSkill scores from Expert: ExpertDomainRequiredSkillScore_k for DomainSkill k (k=1 . . . n)

The transcript analyzer assessment module 135 then reconciles these scores for each skill. Note that in some instances expert scores may not be available. So, the system 100 will have either two or three scores for each skill. Preferably, the transcript analyzer assessment module 135 checks the variance between the available scores.

In preferred embodiments, if two or more scores are within 15% of each other—the transcript analyzer assessment module 135 may compute the average of those within the 15% tolerance, that is the NormalizedDomainRequiredSkillScore_k. If none are within 15%—the transcript analyzer assessment module 135 preferably marks that the skill is not scored, so that NormalizedDomainRequiredSkillScore_k is Null. For soft skills a similar method is used to compute NormalizedSoftSkillScore.

### Identifying Skill Gaps

In some embodiments, first, the system 100 may check if, for any required skill, there is a shortfall. It may count the number of required skills that fall below a threshold (currently set at six but may need to be adjusted to a larger or smaller number).

In preferred embodiments, the system 100 may use the following equation 2 to count skill gaps, such that

$$CountSkillGaps = {\sum }_{k = RequiredSKill 1}^{RequiredSkillm} ( NormalizedDomainRequiredSkillScore\_k < 6 ? 1 : 0 )$$

In this manner, and as described above, the transcript analyzer assessment module 135 may be configured to perform an automated skills assessment for arbitrary skills of the candidate 101, such as in step 706 of method 700 (FIG. 7).

### Use Case—Job Interview and Hiring Decision

In a use case such as a job interview assessment, the system 100 may extract the skills required from the job description, conduct the interview and then do the skill-based scoring. After that, the system 100 may compute an overall score for the assessment and make a hiring recommendation preferably using the results of the following equation to generate an Overall Score, such that:

$$OverallScore = 0.8 * \frac{{\sum }_{s = RequiredSKill 1}^{RequiredSkill} ( NormalizedDomainRequiredSkillScore\_k )}{n} + 0.2 * \frac{{\sum }_{k = SoftSkill 1}^{RequiredSoftSkillm} ( NormalizedSoftSkillScore\_k )}{m}$$

### Behavior Traits Analysis

This section describes the systems and processes used to conduct the automated interview to assess if a candidate 101 possesses and demonstrates a specific behavioral trait. FIG. 3 shows the traits analyzer assessment module 137. In preferred embodiments, the system 100 may comprise, in the system database 120, a catalogue of core values and for each core value a catalogue of behaviors that demonstrate that core value. Alongside, the system database 120 may comprise a curated a set of situations—such as “an experience when you missed the expectation of a colleague, team or client” and for each situation there is a list of core values that could be observed from how a candidate 101 responds to in those situations. FIG. 5 shows the structure and relationships between core values, behavioral traits and associated situations.

Preferably, the interactive interview agent module 134 uses questions with situational context to probe behavior of the candidate 101, and after the interview, the system 100 invokes the traits analyzer assessment module 137 to assess whether the candidate 101 demonstrates certain behavioral traits and mindset required for the job. In preferred embodiments, the interactive interview agent module 134 of the system 100 automates the process of giving a situational context to a candidate 101 and then asking a set of probing questions, such as follows:
“What were you thinking?”
“What were you feeling?”
“What did you say?”
“What did you do?”
“What was the outcome?”

Based on the responses that are processed using the LLMs, the traits analyzer assessment module 137 ascertains whether the behavior traits were demonstrated and whether the core values are shared by this candidate 101.

An example situation may be “an experience when you missed the expectation of a colleague, team or client”. The interactive interview agent module 134 may provide that situation and follow it up with the questions, such as listed in paragraphs 116 to 120. The example situation is connected to a set of core values that can be exhibited in such a situation and some examples of core values connected to this situation are—“Integrity and Ethics”, “Collaboration and Teamwork”, and “Leadership and Ownership”. Each of these core values may be exhibited though a set of behaviors. Some examples of behaviors that are associated with the core value of “Collaboration and Teamwork” are—“Build trust by honoring commitments to the team” and “Support colleagues in achieving their goals”. Based on the responses to the probing questions, the traits analyzer assessment module 137, using the LLMs, can detect presence or absence of these behaviors, and from the behaviors it can connect and identify the presence or absence of core values.

### Feedback Report

Finally, in preferred embodiments, the system 100 generates an interview feedback report for the hiring manager with scores, rationale for scores, and hiring decision by invoking the feedback report module 138. In some embodiments, the feedback report module 138 may also create a document with detail scores and skill gaps meant for the candidate 101. Preferably, the feedback report generated by the feedback report module 138 also includes explanations for the scores citing specific questions and answers provided there to.

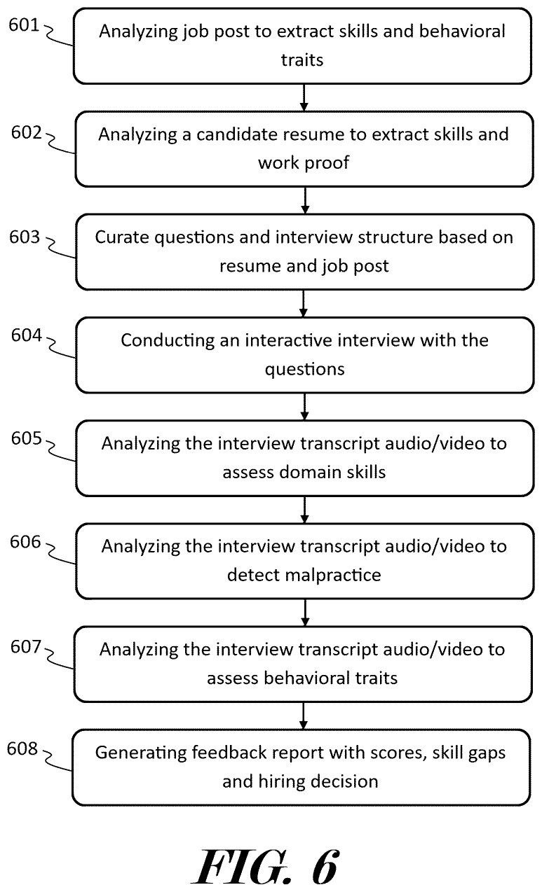

FIG. 6 shows a block diagram of a first example method which may be performed by the system 100 for interview and comprehensive skills assessment of candidates 101 (“the method”) 600 according to various embodiments described herein.

In some embodiments, the method 600 may start and may include analyzing the data, e.g., the text data, of a job post to extract skill and behavioral traits that the job post requires in step 601 via a job benchmark analysis module 131.

In step 602, a candidate 101 resume of a candidate 101 may be analyzed by the candidate resume analysis module 132 to extract skills and work proof of the candidate 101 from the data, e.g., the text data, of the candidate 101 resume.

In step 603, a plurality of question and an interview structure may be curated by a question selector plan generator module 133 based on the data extracted in step 602 and based on data extracted in step 601.

In steep 604, an interactive interview may be conducted in which an artificial intelligence agent 111 is generated on a display screen 404A of a client device 400 operated by or otherwise assigned to the candidate 101 in which the artificial intelligence agent 111 outputs the plurality of questions to the candidate 101, via voice data generated via a speaker 404B. Audio data, recorded by a microphone 404C, and video data, recorded by a camera 404D, of the candidate 101 may be recorded during the artificial intelligence agent's 111 presentation of the plurality of questions to the candidate 101.

In step 605, the interview transcript of the recorded audio and video of the candidate 101 may be analyzed by the transcript analyzer assessment module 135 to assess specific domain skills of the candidate 101, such as in comparison to the data extracted in step 601. An example of this would be as follows—

An example job (Job role 141) may be “Structural Engineer” and one the skills (skill categories 144 or skill subcategories 145) required for the job is “Understanding shear force”.

An example Question obtained by the question selector plan generator module 133 (by querying the LLMs) may be “What is the equation for calculating the shear force in a beam?”

Example Candidate Response may be: “Shear Force is computed by multiplying Beam Width with Beam H eight and dividing the result by 2.”

In this example, the transcript analyzer assessment module 135 may first extract the specific sets of candidate response to this question. Given the interactive nature of the dialog, the question and answer may not be completed in one interaction. The candidate 101 may request for example that the artificial intelligence agent 111 repeat the question. And the candidate 101 may share part of the answer and then pause and have some other interaction with the artificial intelligence agent 111 and after that provide rest of the answer. The transcript analyzer assessment module 135 may go over or review the entire chunk of the transcript from the start of this question until the start of the next question and then thread together all the responses from the candidate 101 for this question. The transcript analyzer assessment module 135 may then use the LLMs to assess the accuracy of the answer. The transcript analyzer assessment module 135 may do so by querying two of the designated LLMs and then triage the responses to arrive at the final analysis. For this example, both the LLMs would return the information that this is wrong and provide explanation of correct answer and how exactly it is wrong—optionally this may be output or provided to the candidate 101 via artificial intelligence agent 111. The scoring rubric may use the sum total of the observations to compute a competency score for the candidate 101 for this skill. The system 100 may use more than one question to assess a skill and would compute the average score of the skill using a scoring rubric.

In step 606, the interview transcript of the recorded audio and video of the candidate 101 may be analyzed by the signature plagiarism module 136 to detect malpractice of the candidate 101. This module preferably checks the audio and video signatures extracted from the transcripts against the prior stored signatures for the candidate 101 to ensure that the right candidate 101 took the interview. It also analyzes the eye tracking of the candidate 101 and background noise to check for other signs of plagiarism.

In step 607, the interview transcript of the recorded audio and video of the candidate 101 may be analyzed by the traits analyzer assessment module 137 to assess behavioral traits of the candidate 101 as described earlier.

In step 608, a feedback report may be generated by the feedback report module 138 which includes scores, skill gaps, and a hiring decision or hiring recommendation as described earlier.

FIG. 7 shows a block diagram of a second example method which may be performed by the system 100 for interview and comprehensive skills assessment of candidates 101 (“the method”) 700 according to various embodiments described herein. Preferably, the method 700 may be used for generating a human expert-like fully interactive interview via the system 100.

In some embodiments, and in step 701, the method 700 may comprise analyzing a job post to extract skill and behavior traits of the job post via a job benchmark analysis module 131 running on a computing platform, such as a server 300 and/or client device 400. Preferably, a job benchmark analysis module 131 may extract skills, traits and other benchmarks associated with a job using the text data and other data of a job posting or job description. This also includes generating minimum threshold scores required for skills associated with the job of the job posting or job description.

In some embodiments, and in step 702, the method 700 may comprise analyzing a candidate resume of a candidate 101 to extract skills and work proof via a candidate resume analysis module 132 running on the computing platform. Preferably, a candidate resume analysis module 132 extracts work history and other experiences of a candidate 101, via text data of their resume, and crafts questions to ask the candidate 101 based on that extracted data.

In some embodiments, and in step 703, the method 700 may comprise curating a plurality of questions and an interview structure based on data of the candidate resume and the extracted skill and behavior traits of the job post via a question selector and plan generator module 133 running on the computing platform. Preferably, the question selector plan generator module 133 dynamically generates questions associated with skills listed in the text data of job posting. These are created on demand when a job is posted and has associated skills and in which the system 100 has not yet created questions for the skills.

In some embodiments, and in step 704, the method 700 may comprise generating the artificial intelligence agent 111 on a client device 400, via an interactive interview agent module 134 running on the computing platform. The artificial intelligence agent 111 may be displayed on a display screen 404A of the client device 400. A speaker 404B of the client device 400 may be operable to output audio data of the artificial intelligence agent 111. A camara 404D of the client device 400 may be operable to record video data of the candidate 101. A microphone 404C of the client device 400 may be operable to audio responses of the candidate 101. In preferred embodiments, the interactive interview agent module 134 and/or the artificial intelligence agent 111 may be configured to dynamically generate a set of questions required to assess a specific domain skill of the candidate 101.

In some embodiments, and in step 705, the method 700 may comprise conducting an interview of the candidate 101 via the artificial intelligence agent 111, in which the artificial intelligence agent 111 interacts with the candidate 101 using a large language model, using the plurality of questions that are output to the candidate 101 via the speaker 404B of the client device 400, using audio responses of the candidate 101 to the plurality of questions recorded by the microphone 404C of the client device 400, and using video data of the candidate 101 recorded by the camera 404D of the client device 400. The audio responses may be processed via the large language model so that the artificial intelligence agent 111 can handle distractions, interruption, and arbitrary questions from the candidate 101 while the artificial intelligence agent 111 records audio responses from the candidate 101, via the microphone 404C, for each question of the plurality of questions. In preferred embodiments, after the interview of the candidate 101 is conducted via the artificial intelligence agent 111, the interactive interview agent module 134 is configured to generate and analyze transcripts of the audio responses and video data of the candidate 101 to score the competency level of the specific domain skill of the candidate 101. In preferred embodiments, the interactive interview agent module 134 may score the competency level of the specific domain skill using scores of each skill required in the analyzed job post, optionally the interactive interview agent module 134 may provide a rationale for the scoring. As an example of this, let us continue with the example in para [000129]. Let's say there were two more questions for the “Shear Force” skill and the questions were about determining the maximum shear force magnitude and its location in a beam and about analyzing the behavior of a structure under varying loads and boundary conditions. The transcript analyzer assessment module 135 may seek the scores from the LLM pairs for each of the answers to these questions. If the transcript analyzer assessment module 135 notes a variant, it may attempt other ways to query the LLMs and after it has the scores it may use the scoring formula discussed in para [000100]. The transcript analyzer assessment module 135 may also receive verbatim explanations of the scores from the LLMs. The system 100 may summarize the explanations across both LLMs to arrive at the scoring rationale that is human understandable. The scores and the rationale may be appended to the transcripts generated by the interview agent module 134. The system 100 may then pass the updated transcripts with scores to the feedback report module 138 which would generate a PDF report.

In some embodiments, and in step 706, the method 700 may comprise performing an automated skills assessment for arbitrary skills of the candidate 101 via a transcript analyzer assessment module 135 as described above. In preferred embodiments, during the step of performing an automated skills assessment for arbitrary skills, the interactive interview agent module 134 may be configured to dynamically generate a set of questions required to assess a specific domain skill of the candidate 101.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random-access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or WiFi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device or client device such as a personal digital assistant (PDA), laptop computer, tablet computer, smartphone, or cellular telephone. The LAN communications network and the other communications networks such as cellular wireless and Wi-Fi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1) A method for generating a human expert-like fully interactive interview via an artificial intelligence agent system, the method comprising:
analyzing a job post to extract skill and behavior traits of the job post via a job benchmark analysis module running on a computing platform;
analyzing a candidate resume of a candidate to extract skills and work proof via a candidate resume analysis module running on the computing platform;
curating a plurality of questions and an interview structure based on data of the candidate resume and the extracted skill and behavior traits of the job post via a question selector and plan generator module running on the computing platform;
generating the artificial intelligence agent on a client device via an interactive interview agent module running on the computing platform, wherein the artificial intelligence agent is displayed on a display screen of the client device, wherein a speaker of the client device is operable to output audio data of the artificial intelligence agent, wherein a camara of the client device is operable to record video data of the candidate, and wherein a microphone of the client device is operable to audio responses of the candidate; and
conducting an interview of the candidate via the artificial intelligence agent, wherein the artificial intelligence agent interacts with the candidate using a large language model, using the plurality of questions that are output to the candidate via the speaker of the client device, using audio responses from the candidate recorded by the microphone of the client device, and using video data of the candidate recorded by the camera of the client device, and wherein the audio responses are processed via the large language model so that the artificial intelligence agent can handle distractions, interruption, and arbitrary questions from the candidate while the artificial intelligence agent records audio responses, via the microphone, from the candidate for each question of the plurality of questions.

2) The method of claim 1, wherein the interactive interview agent module is configured to dynamically generate a set of questions required to assess a specific domain skill of the candidate.

3) The method of claim 1, further comprising the step of performing an automated skills assessment for arbitrary skills of the candidate via a transcript analyzer assessment module.

4) The method of claim 3, wherein after the interview of the candidate is conducted via the artificial intelligence agent, the transcript analyzer module is configured to generate and analyze transcripts of the audio responses and video data to score the competency level of the specific domain skill of the candidate.

5) The method of claim 4, wherein the interactive interview agent module scores the competency level of the specific domain skill using scores of each skill required in the analyzed job post.

6) The method of claim 5, wherein the interactive interview agent module provides a rationale for the scoring.

7) The method of claim 6, wherein the interactive interview agent module uses questions with situational context to probe behavior of the candidate, and wherein after the interview the system invokes a traits analyzer assessment module to assess whether the candidate demonstrates certain behavioral traits and mindset required for the job.
